(19) United States
(12) Patent Application Publication
(10) Pub. No.: US 2023/0036872 A1
(43) Pub. Date: Feb. 2, 2023

(54) Chat User Interface Motif for Transaction Messages

(71) Applicant: Bottomline Technologies, Inc., Portsmouth, NH (US)

(72) Inventors: Jessica Cheney, Tega City, SC (US); Melissa Rose, Copper Hill, VA (US); Paul LaRoche, Kittery, ME (US)

(73) Assignee: Bottomline Technologies, Inc., Portsmouth, NH (US)

(21) Appl. No.: 17/965,011

(22) Filed: Oct. 13, 2022

Related U.S. Application Data
(63) Continuation-in-part of application No. 29/841,945, filed on Jun. 9, 2022.
Application No. 29/841,945 is a continuation of application No. 29/688,550, filed on Apr. 23, 2019, now Pat. No. D956087.
Application No. 29/688,550 is a continuation of application No. 16/391,480, filed on Apr. 23, 2019, now abandoned.

(51) Int. Cl. G06Q 20/32; G06F 3/04847; G06Q 20/02; G06F 3/0482; H04L 51/04

(52) U.S. Cl. CPC G06Q 20/3255; G06F 3/04847; G06Q 20/023; G06F 3/0482; H04L 51/04

(57) ABSTRACT

A unique user interface for presenting the messages transmitted on a real-time processing rail is described herein, where the messages are displayed using a chat motif. The user interface includes a summary of all instructions, with a variable icon indicating whether the instruction also includes messages. If a user selects the variable icon, a chat-like window or conversational drawer is presented to allow the user to enter and receive messages related to that specific instruction.

### PRIOR APPLICATION

This application is a Continuation-in-part of U.S. patent application Ser. No. 29/841,945, filed by the inventors on Jun. 9, 2022, incorporated herein by reference. U.S. patent application Ser. No. 29/841,945 is a Continuation of application of U.S. patent application Ser. No. 29/688,550, filed by the inventors on Apr. 23, 2019, now U.S. Pat. D956,087 issued on Jun. 28, 2022, incorporated herein by reference. U.S. Pat. D956,087 is a Continuation of application Ser. No. 16/391,480, filed by the inventors on Apr. 23, 2019, incorporated herein by reference.

### BACKGROUND

### Technical Field

The system, apparatuses, and methods described herein generally relate to an improved user interface for transactions, and specifically to the use of a chat motif in the display of transaction messages.

### BRIEF SUMMARY OF THE INVENTIONS

In some aspects, the techniques described herein relate to a non-transitory computer-readable medium having stored thereon: chat user interface software programmed to accept alphanumeric messages from a user, said alphanumeric messages entered by the user in a chat box, the chat user interface software being programmed to display details of a real-time instruction in the chat box, the alphanumeric messages associated with the real-time instruction; the chat user interface software programmed to exchange the real-time instruction and the alphanumeric messages between the user and a remote beneficiary at a beneficiary computer over a real-time processing rail by way of a clearing house computer, the chat user interface software being programmed to transmit and receive the real-time instruction and the alphanumeric messages, and a special purpose secure network defined within protocols of the real-time processing rail, the real-time instruction and the alphanumeric messages sent with and received over the special purpose secure network using encryption and point-to-point tunneling defined within the real-time processing rail's protocol to connect the chat user interface software to the clearing house computer, the clearing house computer being a computing device programmed to route the real-time instruction and the alphanumeric messages between institutions; and the chat user interface software programmed to display the alphanumeric messages exchanged with the remote beneficiary in a chat format, each alphanumeric message displayed in its own text box on a computer screen.

In some aspects, the techniques described herein relate to a non-transitory computer-readable medium, the chat user interface software being programmed to transmit and receive the alphanumeric messages in association with the real-time instruction identified by an instruction ID.

In some aspects, the techniques described herein relate to a non-transitory computer-readable medium, the chat user interface software being programmed to run as software-as-a-service.

In some aspects, the techniques described herein relate to a non-transitory computer-readable medium, the chat user interface software operates in a browser connected to a web server on an institution computer.

In some aspects, the techniques described herein relate to a non-transitory computer-readable medium, the chat user interface software being programmed to accept the alphanumeric messages from a pulldown menu.

In some aspects, the techniques described herein relate to a non-transitory computer-readable medium, the chat user interface software being programmed to accept the alphanumeric messages from radio buttons.

In some aspects, the techniques described herein relate to a non-transitory computer-readable medium, the chat user interface software being programmed to accept the alphanumeric messages from a freeform text field.

In some aspects, the techniques described herein relate to a non-transitory computer-readable medium wherein the chat user interface software runs on a beneficiary's computer.

In some aspects, the techniques described herein relate to a non-transitory computer-readable medium wherein the text boxes are programmed to appear on a foreground window that appears as a conversational drawer, where the conversational drawer slides out across a background window as an overlay.

In some aspects, the techniques described herein relate to a non-transitory computer-readable medium wherein the chat user interface software is programmed to display a beneficiary name and an amount extracted from the real-time instruction.

In some aspects, the techniques described herein relate to a method including: displaying details of a real-time instruction in a chat box; accepting alphanumeric messages from a user by chat user interface software, said alphanumeric messages entered by the user in the chat box, said alphanumeric messages associated with the real-time instruction; exchanging, by the chat user interface software, the real-time instruction and the alphanumeric messages between the user and a remote beneficiary at a beneficiary computer over a real-time processing rail by way of a clearing house computer, the chat user interface software being programmed to transmit and receive the real-time instruction and the alphanumeric messages, and a special purpose secure network defined within protocols of the real-time processing rail, the real-time instruction and the alphanumeric messages sent with and received over the special purpose secure network using encryption and point-to-point tunneling defined within the real-time processing rail's protocol to connect the chat user interface software to a clearing house computer, the clearing house computer being a computing device programmed to route the real-time instruction and the alphanumeric messages between institutions; and displaying, by the chat user interface software, the alphanumeric messages exchanged with the remote beneficiary in a chat format in a window associated with the real-time instruction on a computer screen.

In some aspects, the techniques described herein relate to a method wherein the real-time instruction is identified by an instruction ID.

In some aspects, the techniques described herein relate to a method wherein the chat user interface software is programmed to run as software-as-a-service.

In some aspects, the techniques described herein relate to a method wherein the chat user interface software uses a software-as-a-service interface to an institution's computer.

In some aspects, the techniques described herein relate to a method wherein the chat user interface software is programmed to accept the alphanumeric messages from a pulldown menu.

In some aspects, the techniques described herein relate to a method wherein the chat user interface software is programmed to accept the alphanumeric messages from radio buttons.

In some aspects, the techniques described herein relate to a method wherein the chat user interface software is programmed to accept the alphanumeric messages from a freeform text field.

In some aspects, the techniques described herein relate to a method further including displaying a beneficiary name and an amount extracted from the real-time instruction in the window.

In some aspects, the techniques described herein relate to a method wherein the window appears as a conversational drawer, where the conversational drawer slides out across a background window as an overlay.

### BRIEF DESCRIPTION OF THE DRAWINGS

FIG. 1 is a screenshot of a Real-time Payments screen including several payments submitted and received.

FIG. 2 shows a portion of a screen for starting a Real-time Payment related conversation.

FIG. 3 shows a portion of a screen for entering a Real-time Payment related message.

FIG. 4 illustrates an exchange of several Real-time Payment messages when payment is received.

FIG. 5 illustrates an exchange of several Real-time Payment messages when payment is submitted.

FIG. 6 is a screenshot of a detailed Real-time Payment showing the closed message icon.

FIG. 7 shows the detailed Real-time Payment screen with the message conversation overlaid.

FIGS. 8a-f show several other ways of showing messages in a conversation.

FIG. 9 is a hardware diagram showing a Real-time Payments banking network.

### DETAILED DESCRIPTION

For the first time in forty years, The Clearing House and the US banking industry introduced a new banking protocol to manage payments between paying entities. The new protocol, called real-time payments or RTP for short, provides for settlement within seconds, with little opportunity to reverse the transaction. The payments system is available 24 hours per day, 7 days per week, 365 days per year. The protocol also supports transferring short comments either along with the payment or along with associated message packets between the parties creating and receiving the transaction. The protocol will be available to all US financial institutions and eventually will support international transfers. The RTP system allows users to maintain control over their accounts, supporting only credit push, and does not allow anyone to pull funds directly from a payer's account. In addition, received funds are immediately available, within seconds, of the transfer.

RTP also supports flexible messaging options including payment messages, sending non-payment messages, and referencing external remittance sources. This enhanced messaging option, however, does not come with a robust user interface to provide users with a means for utilizing this enhanced feature set. The present set of inventions provides an improved user interface for real-time bank payments.

The Real-time Payments banking protocol outlines a number of packets that permit the transfer of 140-character messages between the payer and the beneficiary. While the definition of the RTP protocol details the messages, there is no description of how to present this information to the users and to allow entry of these messages. Applicants have invented a technique for presenting these messages in a chat-like format, using chat user interface software, for example, see the description below.

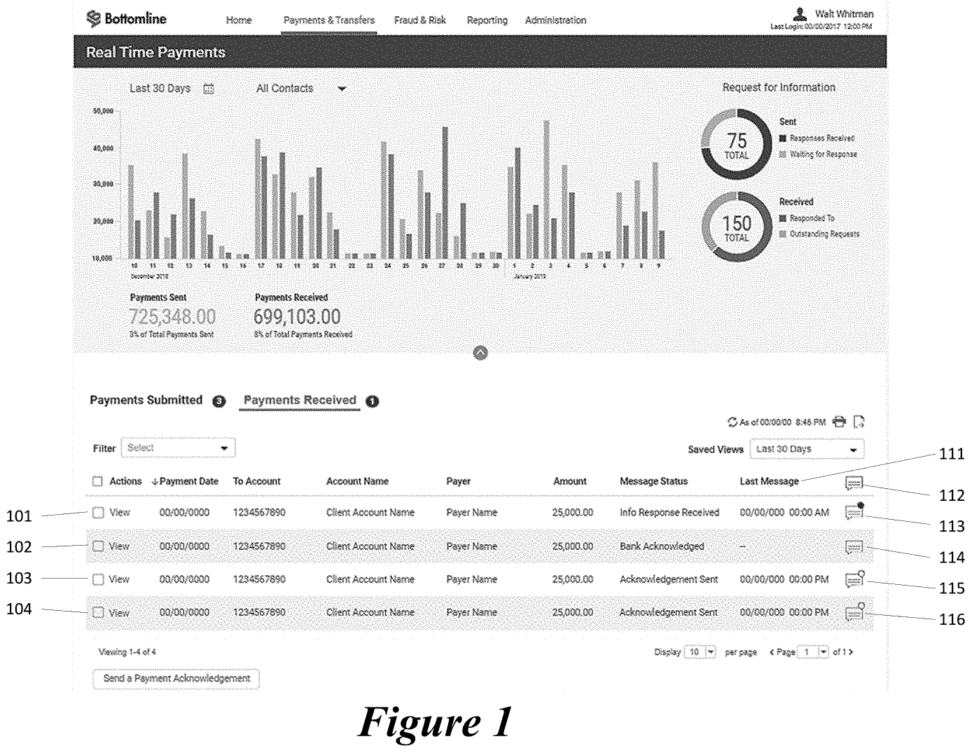

Looking at FIG. 1, we see a Real-time Payments screen showing the transactions for a period of time. The top of the screen shows the payments for the last 30 days in graphical form, highlighting the payments submitted and received through the RTP protocol. In addition, there are circle graphics showing the requests for information sent and received, along with the number of inquiries that are outstanding. These are the messages that are described in detail below.

At the bottom of the screen in FIG. 1 we see four payment records 101, 102, 103, 104. Each of these records are for payments received. Selecting Payments Submitted on the screen displays the outgoing payments. The first record 101 is a payment received in the amount of $25,000 from “Payer Name”, that the payment went to account 1234567890, “Client Account Name”.

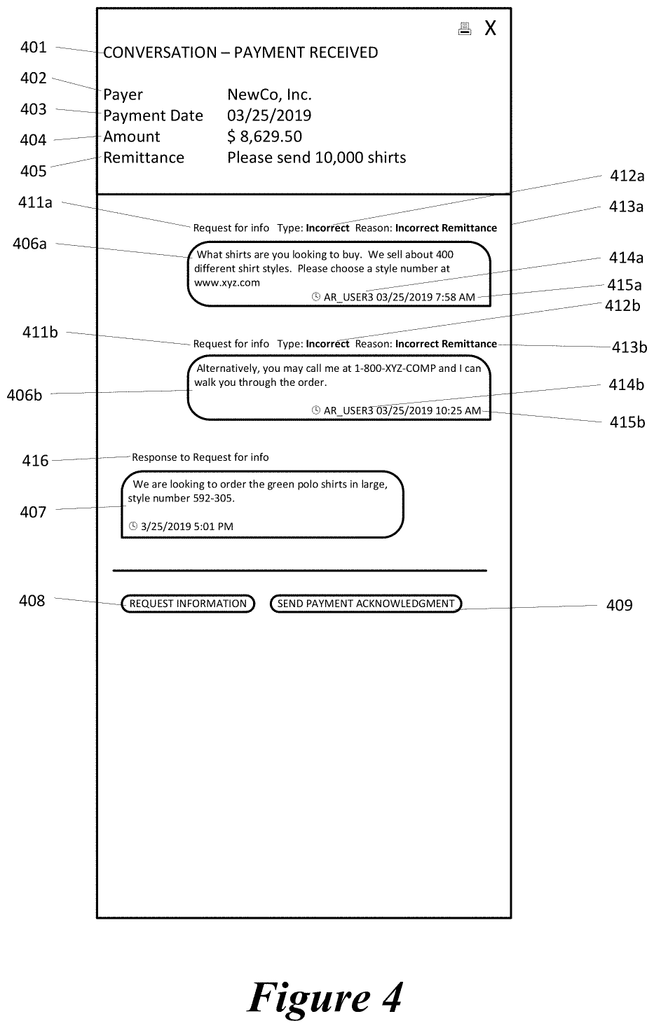

Looking at the message column 112, we see the message icon 113 for the first record 101 has a solid black circle in the top right corner. This indicates that an unread message is waiting on the message screen. The Message Status states that “Info Response Received”, and the Last Message column 111 shows the date and time that the last message arrived. Clicking on the message icon 112 will bring up a message window similar to FIG. 4, showing the alphanumeric message. In some embodiments, this message window appears as a conversational drawer, where the drawer slides out across the background window as an overlay.

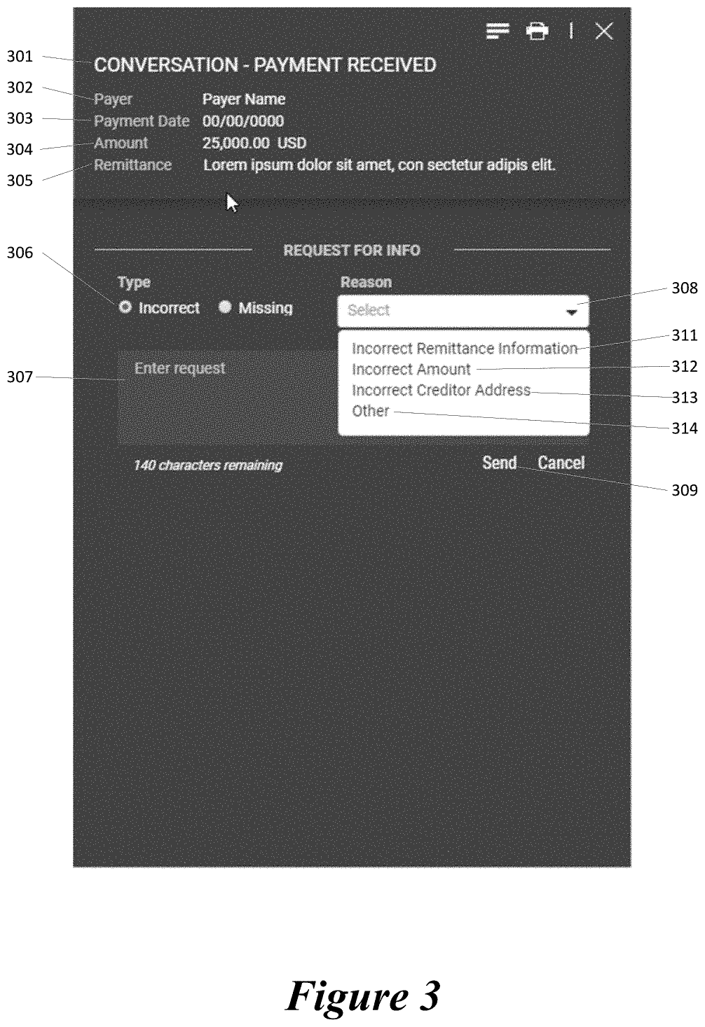

The second record 102 does not have a conversation associated with it. The message icon 114 does not have a circle in the top right corner. The message status is “Bank Acknowledged”, indicating that the remote bank acknowledged that the payment was received, but that the user has not yet acknowledged the receipt of payment. If the user clicks on the message icon 114, a message window similar to FIG. 3 appears.

The third and fourth records 103, 104 are similar. Both have an open circle in the top right corner of the message icon 115, 116. This indicates that there are messages, but that all of the messages have been previously read. Clicking on the message icon 115, 116 would bring up a conversational drawer window similar to FIG. 4.

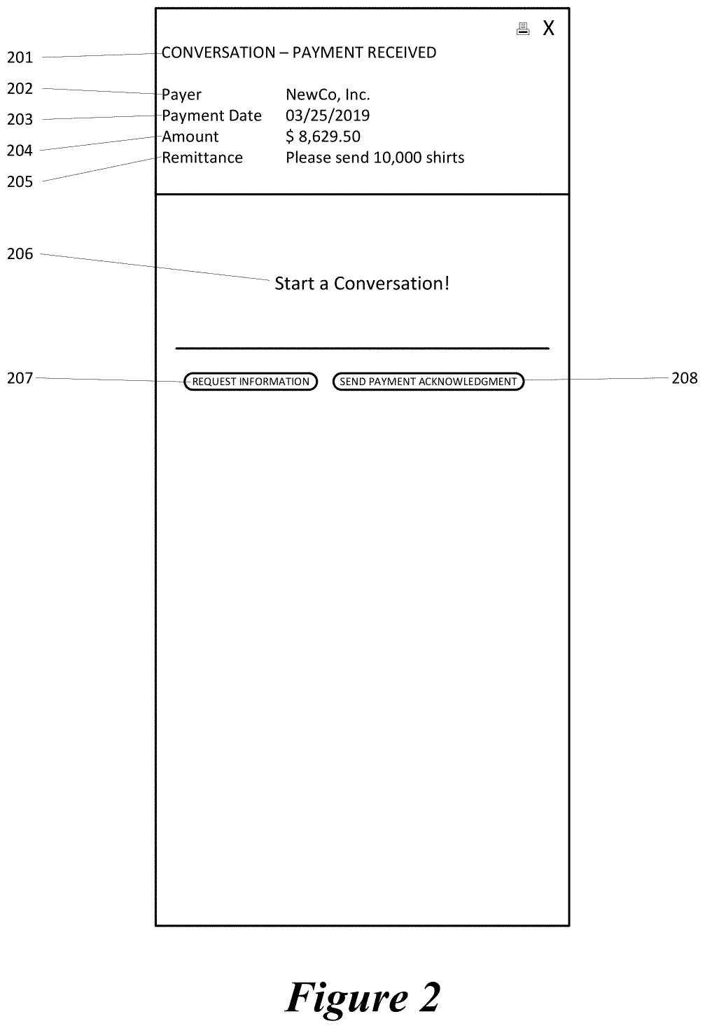

FIG. 2 is a window for starting a conversation over the banking rail using Real-time Payments. At the top of the window, the title 201 describes the type of conversation; this is a “Payment Received” conversation. Each conversation type has slightly different rules to conform the conversation to the RTP protocol requirements. The header of the window also lists the payer 202, the payment date 203 (this could also include the payment time), the amount of the payment 204 optionally including the currency, and the remittance message 205 that provides context information regarding the payment (for instance, invoice number or project name). Note that any of these fields could be eliminated or the order changed without departing from the inventions herein. A “start a conversation” instruction 206 is in the center of the screen. To start the conversation, the user selects either the Request Information 207 or the Send Payment Acknowledgment 208 buttons. For example, if the Remittance field 205 is empty or incomplete, the user may request information 207 from the payer regarding the reason for the payment.

FIG. 3 shows a window for requesting additional information. The header is the same as in FIG. 2, with the title 301 at the top, the payer 302, the payment date 303, the amount of the payment 304, and the remittance message 305 providing the context for the payment.

Below the header are the fields requesting information. In one embodiment, the user first needs to select whether this request is related to incorrect or missing information 306, possibly selected from radio buttons. Then the reason 308 is selected from a pulldown menu. Reasons 308 are selected from a drop-down list in this embodiment. The drop-down selections are Incomplete Remittance Information 311, Incorrect Amount 312, Incorrect Creditor Address 313, or Other 314. Once the reason for accepting the information is selected, the user adds additional details in the freeform text field 307. In one embodiment, this text is limited to 140 characters. Once the information is entered, the user selects Send 309 to transmit the message over the banking rail to the Payer or Cancel to delete the draft message and return to the previous window.

FIG. 4 shows the conversation after several messages are exchanged between the Payer and the user (Beneficiary). The header is the same as in FIG. 2 and FIG. 3, with the title 401 at the top, the payer 402, the payment date 403, the amount of the payment 404, and the remittance message 405 providing the context for the payment.

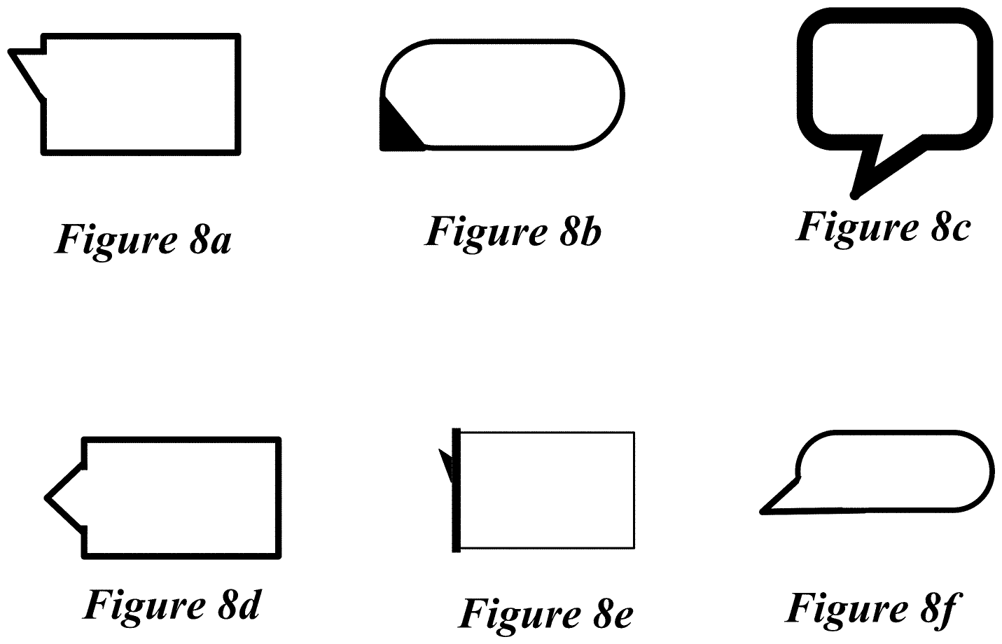

Looking at the first message 406a, it is a Request for Information 411a, with the type set to incorrect 412a, and the reason as incorrect remittance 413a. The text of the message 406a is in a rounded corner box with a square lower right corner. The message box is on the right indicating that the message is from the user in this embodiment. In some embodiments, the color of the message box could also be darker, indicating that this message is from the user. Other shapes for the message box can be found in FIGS. 8a-f, representing alternative embodiments. In some embodiments, messages received from the other party of the transaction are displayed on the left side of the screen, have a square lower left corner, and are lighter in color.

Also in the text box 406a is the user id 414a of the user that entered the message. This designation is needed because several individuals could access the same message stream. For example, there may be three individuals in the accounts receivable department, each with access to the payment system. The user id 414a field allows the specification of who requested additional information. In addition, the date and time of the message 415a is included in the text box 406a. Changes to the format or exclusion of the time or date 415a do not detract from the inventions herein.

The second message 406b is a follow on message with a similar request for information 411b, type 412b, and reason 413b. The message 406b also includes the user id 414b and date and time 415b. The second message could be used to provide additional information when the 140 characters are not enough. Or it could be used as a reminder if there is no response to the first message.

The third message in FIG. 4 shows a response to the request for info 416 received from the payer. The message includes text in the text field 407, as well as the date and time. The user id is not sent over the wire, so there is no remote user id displayed in this embodiment. Other embodiments could include the remote user id in the message and in the window.

In response to the third message, the user could request additional information 408 from the payer. Selecting the request additional information button 408 returns the user to the window in FIG. 3. Alternatively, the send payment acknowledgment button 409 could be selected. The send payment acknowledgment 409 brings up a text entry box in the window below the third message 407 with the option to send or cancel.

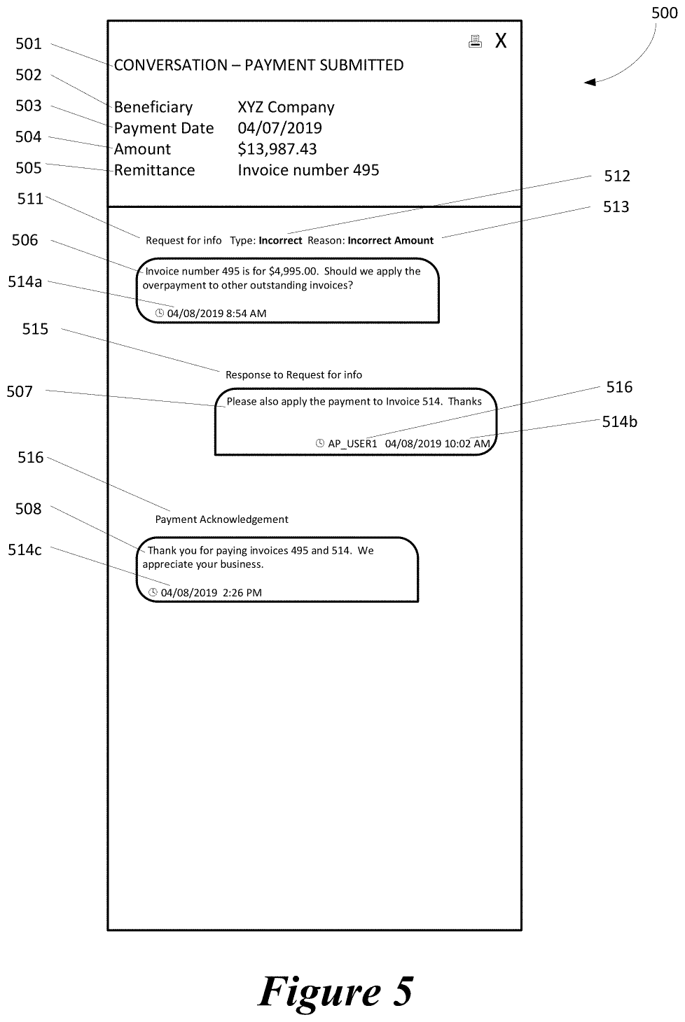

FIG. 5 shows the other side of the conversation, from the payee (also called the beneficiary) point of view 500. The title 501 explains that this conversation is regarding a payment that the user submitted. The beneficiary 502 name is listed, as is the payment date 503 (and time in some embodiments), and the payment amount 504. The remittance message 505 is also displayed.

Looking to message one 506, we see a request for information 511 from the beneficiary. The type 512 is incorrect and the reason 513 is an incorrect amount. The text of the message 506 is in the text box, along with the date the message was sent 514a. In this embodiment, because the text box is on the left side of the window, this message was received from the beneficiary.

The second message 507, was received from the user, as indicated by the color and that the message is on the right side of the screen. The second message 507 is a response to a request for information 515. Because this message is on the user's side of the communication, a user id 516 is displayed, as is the date and time 514b. Typically, this message 507 describes why the incorrect amount was sent.

The third message 508 in this example is a payment acknowledgment 516. The acknowledgment includes optional text 508 and a date/time stamp 514c. Since the payment is acknowledged, the conversation stops, and the user has no ability to send a response in this embodiment.

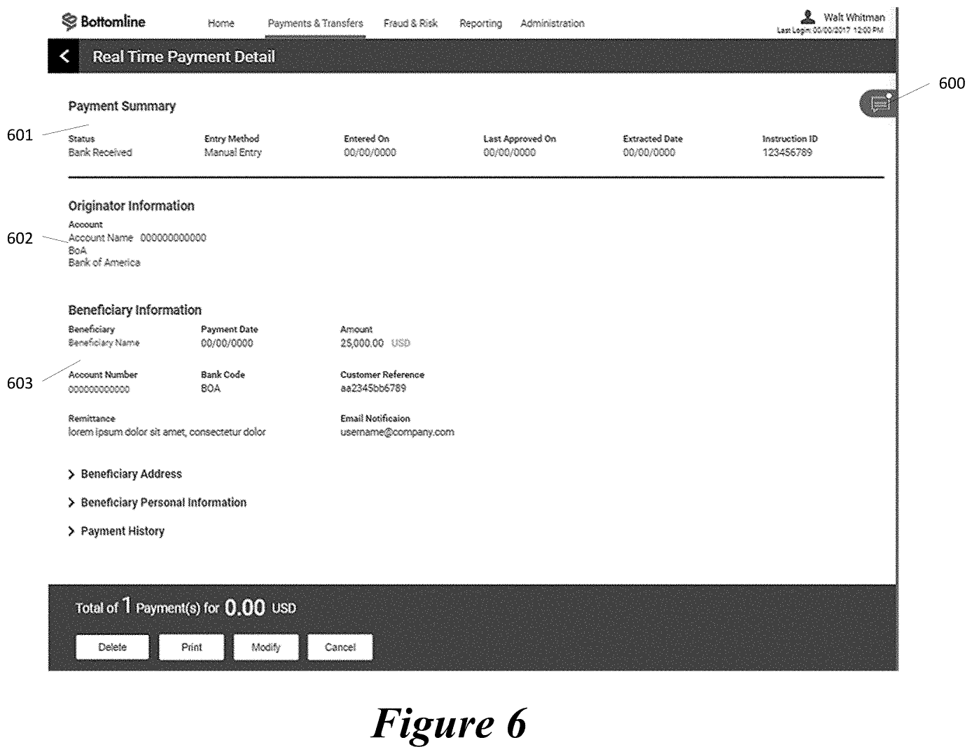

FIG. 6 shows a screen displaying the real-time payment detail. In one embodiment, this screen will appear if the user clicks on a payment 101, 102, 103, 104 in FIG. 1. The payment summary 601 appears at the top of the screen indicating that the financial institution (for instance, a bank or other similar institution) has received the payment, the instruction ID, how the payment was entered, when it was entered, when it was approved, and when the payment was transmitted. The dates (here and elsewhere in this document) could be the dates alone, the time alone, a combination of data and time, and could be in any format. Below the payment summary 601 is the originator (or payer) information 602 showing the account name, bank name, and bank information.

Below the originator information 602 is the beneficiary information. This includes the beneficiary name, the beneficiary account number, the beneficiary bank, the payment date, and the amount. Additional information such as a customer reference, an email notification, and a remittance message could also be included. Additional information on the beneficiary and the payment history could be found by expanding the information under the beneficiary address, beneficiary personal information, and payment history lines.

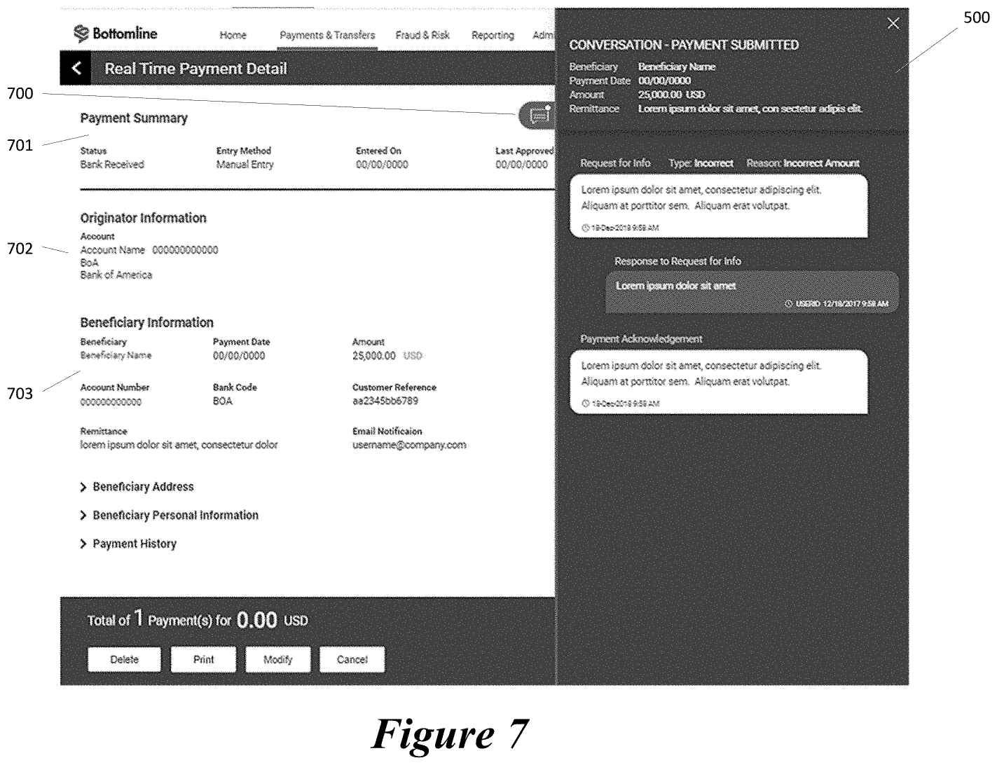

The message icon 600 in the upper right corner of the screen hides the conversations related to this payment. Clicking on the message icon 600 causes the conversation to be expanded as seen in FIG. 7. In this figure, the message icon 600 has a solid circle on the upper right corner of the icon, indicating that there are unread messages in the conversation. If the circle were empty, then there are messages, but all messages have been reviewed. A message icon 600 without a circle has no messages. In other embodiments, different methods are used to show the three states of messages. A number of unread messages could be placed in the message icon 600 in one embodiment. Different colors, or a flashing icon, could be used in other embodiments to indicate that messages are present.

Clicking on the message icon 600 causes the conversation 500 to be displayed, as seen in FIG. 7. In some embodiments, the conversation is displayed through a conversational drawer mechanism where the drawer slides out across the underlying window as an overlay. Clicking on the message icon 700 or on the X in the upper right corner of the window 500 will cause the window 500 to collapse back into the message icon 600 as seen in FIG. 6 sliding the conversational drawer closed in some embodiments. The screen in FIG. 7 also includes the payment summary 701, the originator information 702, and the beneficiary information 703.

FIGS. 8a, 8b, 8c, 8d, 8e, and 8f all show different styles of text boxes for different embodiments of the inventions. Each of these text boxes can be inverted to show the other side of a conversation. Each of these could be rotated in different directions in still other embodiments. Each of these options can be substituted for the text boxes as seen in FIGS. 4, 5, and 7.

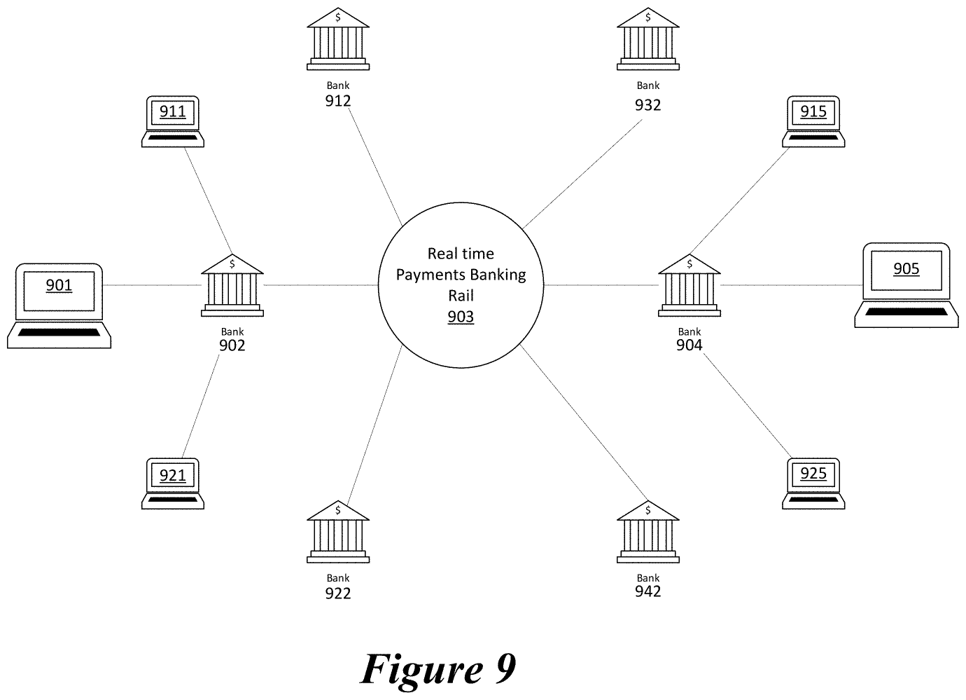

FIG. 9 shows a real-time payments banking network. The payer's computer 901 is connected to the payer's bank computer 902 through a secure network connection. This connection could be a direct hard wire, a wireless network, a local area network, or the internet. The payer's bank computer 902 is connected to the payer's computer 901 as well as a plurality of other customers' computers 911, 921. In the same way, the beneficiary's computer 905 is connected to the beneficiary's bank's computer 904. Each bank computer 902, 904, 912, 922, 932, 942 is connected to the real-time payments processing rail 903 (also called a real-time processing rail). The rail 903 is a special purpose secure networking system and clearing house computer connecting the bank computers 902, 904, 912, 922, 932, 942 (also called an institution computer) together. The clearing house computer is a special-purpose device that routes messages and payments using high-performance routing techniques. While this network may operate over the internet (or another wide area network), the formatting of the message assures that the messages are transmitted on a secure channel that prevents interference from other parties through encryption and point-to-point tunneling. Furthermore, the protocol may assure delivery of the messages and may assure real-time delivery of the messages. The payment message is formatted into a real-time instruction or a real-time payment instruction. These instructions direct the financial institutions to credit certain accounts and debit others, effectuating the payment.

In some cases, the bank computer 902 is connected directly to the beneficiary computer 905, and the payments and messages do not need to go through the real-time payments banking rail 903.

In some embodiments, the user interface software is designed to run in a software-as-a-service configuration. In this configuration, the user could connect directly to software-as-a-service software on a third-party computer (or on a bank computer). In another aspect of the software-as-a-service configuration, a thin client software interface is sent to a user computer from the software-as-a-service server for execution locally, perhaps in a web browser.

The user interface described above in FIGS. 1-7 could run on the payer's computer 901, the payer's bank computer 902, the beneficiary's computer 905, the beneficiary's bank computers 904, or any of the other computers 911, 921, 915, 925 or bank computers 912, 922, 932, 942. The user interface could operate in a browser to a web server on the payer's bank computer 902, using a software-as-a-service interface to the bank computer 902, using software operating on the payer's computer 901, or any similar combination of hardware and software. Each computer may have one or more processors, memory (such memory (non-transitory computer-readable medium) to hold non-transitory computer-readable instructions and other data), network interfaces, display screens, user input devices, etc. The processor is programmed with the non-transitory computer-readable instructions to perform the steps described above.

In a typical scenario, the payer will initiate a payment by utilizing the user interface on the payer's computer 901. The payment message contains information similar to that in FIG. 6: originator information 602, beneficiary information 603, including the amount, and remittance information. This will generate a payment message to the payer's bank computer 902. The payer's bank computer 902 forwards the message to the real-time payments banking rail 903. The banking rail 903 routes the message to the beneficiary's bank computer 904. The beneficiary's bank computer 904 then forwards the message to the beneficiary's computer 905.

The beneficiary then uses the user interface (there is no requirement that both the payer and the beneficiary use the same user interface software) on the beneficiary computer 905 to either acknowledge the payment (see FIG. 5) or to send a message requesting additional information (see FIG. 3). The acknowledgment or request for information is sent from the beneficiary computer 905 to the beneficiary's bank computer 904, where the message is then sent to the banking rail 903, and on to the payer's bank 902, and finally to the payer's computer 901.

The foregoing devices and operations, including their implementation, will be familiar to, and understood by, those having ordinary skill in the art.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A non-transitory computer-readable medium having stored thereon:
chat user interface software programmed to accept alphanumeric messages from a user, said alphanumeric messages entered by the user in a chat box, the chat user interface software being programmed to display details of a real-time instruction in the chat box, the alphanumeric messages associated with the real-time instruction;
the chat user interface software programmed to exchange the real-time instruction and the alphanumeric messages between the user and a remote beneficiary at a beneficiary computer over a real-time processing rail by way of a clearing house computer, the chat user interface software being programmed to transmit and receive the real-time instruction and the alphanumeric messages, and a special purpose secure network defined within protocols of the real-time processing rail, the real-time instruction and the alphanumeric messages sent with and received over the special purpose secure network using encryption and point-to-point tunneling defined within the real-time processing rail's protocol to connect the chat user interface software to the clearing house computer, the clearing house computer being a computing device programmed to route the real-time instruction and the alphanumeric messages between institutions; and
the chat user interface software programmed to display the alphanumeric messages exchanged with the remote beneficiary in a chat format, each alphanumeric message displayed in its own text box on a computer screen.

2. The non-transitory computer-readable medium of claim 1, the chat user interface software being programmed to transmit and receive the alphanumeric messages in association with the real-time instruction identified by an instruction ID.

3. The non-transitory computer-readable medium of claim 1, the chat user interface software being programmed to run as software-as-a-service.

4. The non-transitory computer-readable medium of claim 1, the chat user interface software operates in a browser connected to a web server on an institution computer.

5. The non-transitory computer-readable medium of claim 1, the chat user interface software being programmed to accept the alphanumeric messages from a pulldown menu.

6. The non-transitory computer-readable medium of claim 1, the chat user interface software being programmed to accept the alphanumeric messages from radio buttons.

7. The non-transitory computer-readable medium of claim 1, the chat user interface software being programmed to accept the alphanumeric messages from a freeform text field.

8. The non-transitory computer-readable medium of claim 1 wherein the chat user interface software runs on a beneficiary's computer.

9. The non-transitory computer-readable medium of claim 1 wherein the text boxes are programmed to appear on a foreground window that appears as a conversational drawer, where the conversational drawer slides out across a background window as an overlay.

10. The non-transitory computer-readable medium of claim 1 wherein the chat user interface software is programmed to display a beneficiary name and an amount extracted from the real-time instruction.

11. A method comprising:
displaying details of a real-time instruction in a chat box;
accepting alphanumeric messages from a user by chat user interface software, said alphanumeric messages entered by the user in the chat box, said alphanumeric messages associated with the real-time instruction;
exchanging, by the chat user interface software, the real-time instruction and the alphanumeric messages between the user and a remote beneficiary at a beneficiary computer over a real-time processing rail by way of a clearing house computer, the chat user interface software being programmed to transmit and receive the real-time instruction and the alphanumeric messages, and a special purpose secure network defined within protocols of the real-time processing rail, the real-time instruction and the alphanumeric messages sent with and received over the special purpose secure network using encryption and point-to-point tunneling defined within the real-time processing rail's protocol to connect the chat user interface software to the clearing house computer, the clearing house computer being a computing device programmed to route the real-time instruction and the alphanumeric messages between institutions; and
displaying, by the chat user interface software, the alphanumeric messages exchanged with the remote beneficiary in a chat format in a window associated with the real-time instruction on a computer screen.

12. The method of claim 11 wherein the real-time instruction is identified by an instruction ID.

13. The method of claim 11 wherein the chat user interface software is programmed to run as software-as-a-service.

14. The method of claim 11 wherein the chat user interface software uses a software-as-a-service interface to an institution's computer.

15. The method of claim 11 wherein the chat user interface software is programmed to accept the alphanumeric messages from a pulldown menu.

16. The method of claim 11 wherein the chat user interface software is programmed to accept the alphanumeric messages from radio buttons.

17. The method of claim 11 wherein the chat user interface software is programmed to accept the alphanumeric messages from a freeform text field.

18. The method of claim 11 further comprising displaying a beneficiary name and an amount extracted from the real-time instruction in the window.

19. The method of claim 11 wherein the window appears as a conversational drawer, where the conversational drawer slides out across a background window as an overlay.
